(19) United States
(12) Patent Application Publication
(10) Pub. No.: US 2018/0121161 A1
(43) Pub. Date: May 3, 2018

(54) ELECTRONIC DEVICE, CONTROL METHOD, AND STORAGE MEDIUM

(71) Applicant: KYOCERA Corporation, Kyoto-shi (JP)

(72) Inventors: Yasuhiro UENO, Yokohama-shi (JP); Shigeki TANABE, Yokohama-shi (JP); Hideki MORITA, Yokohama-shi (JP); Isao MASUIKE, Tokyo (JP); Koutaro YAMAUCHI, Yokohama-shi (JP); Manabu SAKUMA, Yokohama-shi (JP)

(21) Appl. No.: 15/794,721

(22) Filed: Oct. 26, 2017

(30) Foreign Application Priority Data
Oct. 28, 2016 (JP) 2016-211553

(51) Int. Cl. G06F 3/16; G10L 15/22; G10L 15/08; G06F 3/041; G10L 17/00

(52) U.S. Cl. CPC G06F 3/167; G10L 15/22; G10L 15/08; G10L 2015/088; G10L 17/005; G10L 2015/223; G06F 3/0412

(57) ABSTRACT

An electronic device includes a display, a voice input unit, a detector configured to detect a certain change in the electronic device or in a vicinity of the electronic device, and a controller configured to display an application screen on the display. The controller is configured to accept an input of first voice for displaying the application screen, if the certain change is detected while the application screen is not being displayed.

### CROSS-REFERENCE TO RELATED APPLICATION(S)

The present application claims priority under 35 U.S.C. § 119 to Japanese Patent Application No. 2016-211553, filed on Oct. 28, 2016, entitled “ELECTRONIC DEVICE, CONTROL METHOD, AND COMPUTER PROGRAM”. The content of which is incorporates by reference herein in its entirety.

### FIELD

The present application relates to an electronic device provided with a voice recognition function.

### BACKGROUND

Conventionally, a system and a method for validating a voice trigger that causes a device to activate a voice command and that is similar to manually starting (pressing a button of) a voice command function have been disclosed.

### SUMMARY

An electronic device according to one aspect includes a display, a voice input unit, a detector configured to detect a certain change in the electronic device or in a vicinity of the electronic device, and a controller configured to display an application screen on the display. The controller is configured to accept an input of first voice for displaying the application screen, if the certain change is detected while the application screen is not being displayed.

A control method according to one aspect of an electronic device that includes a display, a voice input unit, a detector for detecting a certain change in the electronic device or in a vicinity of the electronic device, and a controller for displaying an application screen on the display, includes detecting the certain change while the application screen is not being displayed, and accepting an input of first voice for displaying the application screen.

A non-transitory storage medium that stores a control program for causing, when executed by an electronic device including a display, a voice input unit, a detector configured to detect a certain change in the electronic device or a vicinity of the electronic device, and a controller configured to display an application screen on the display, the electronic device to execute detecting the certain change while the application screen is not being displayed, and accepting an input of first voice for displaying the application screen.

### BRIEF DESCRIPTION OF THE DRAWINGS

FIG. 1 is an external view of an electronic device according to embodiments;

FIG. 2 is an image view illustrating an example of a home screen;

FIG. 3 is an image view illustrating an example of an application screen;

FIG. 4 is a block diagram illustrating a functional configuration of the electronic device according to the embodiments;

FIG. 5 is an image view illustrating an example of an operation of the electronic device according to the embodiments;

FIG. 6 is a flow chart illustrating a first example of control performed by the electronic device according to the embodiments; and

FIG. 7 is a flow chart illustrating a second example of control performed by the electronic device according to the embodiments.

### DETAILED DESCRIPTION

Embodiments according to the present application will now be described in detail with reference to the accompanying drawings. However, the present application is not limited to the following embodiments. Moreover, components in the following description include those that can be easily assumed by a person skilled in the art, that are substantially identical, or that fall within what is called range of equivalents. In the drawings, the same reference numerals denote the same components, and repeated descriptions may be omitted. A user may need a voice trigger to operate an electronic device with voice. However, the user may sometimes feel troublesome to use the voice trigger.

In the following, for example, an electronic device 1 according to some embodiments of the present application may be a terminal such as what is called a smartphone. However, the electronic device 1 according to the embodiments of the present application is not limited to the smartphone. For example, the electronic device 1 may be a tablet, a personal computer, an in-vehicle electronic device, and the like.

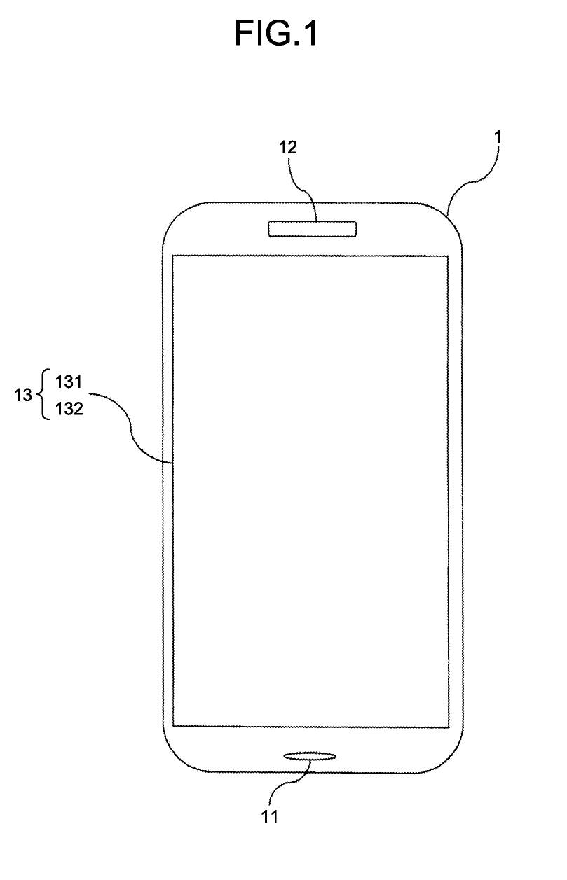

FIG. 1 is an external view of the electronic device 1 according to some embodiments. As illustrated in FIG. 1, the electronic device 1 includes a microphone 11 as a voice input unit, a speaker 12 as a voice output unit, and a touch panel 13.

The microphone 11 is one of input units that accepts an input to the electronic device 1. The microphone 11 collects the surrounding voice.

The speaker 12 is one of output units that outputs from the electronic device 1. Voice from a telephone, information on various computer programs, and the like are output from the speaker 12 in the form of voice.

The touch panel 13 includes a touch sensor 131 and a display 132.

The touch sensor 131 is one of input units that accepts input to the electronic device 1. The touch sensor 131 detects contact of a user's finger, a stylus, and the like. For example, a method of detecting contact includes a resistive film method, an electrostatic capacitance method, and the like. However, the method of detecting contact may be any desired method.

The display 132 is one of output units that implements output from the electronic device 1. The display 132 displays objects such as characters, images, symbols, and diagrams, on a screen. For example, the display 132 includes a liquid crystal display and an organic electroluminescence (EL) display.

In the touch panel 13 in FIG. 1, the display 132 and the touch sensor 131 are provided in an overlapping manner, and a display area of the display 132 is overlapped with the touch sensor 131. However, some embodiments are not limited thereto. For example, the display 132 and the touch sensor 131 may be disposed side by side, or may be disposed separate from each other. When the display 132 and the touch sensor 131 are overlapped with each other, one or a plurality of sides of the display 132 need not be arranged along any of the sides of the touch sensor 131.

The electronic device 1 determines a type of gestures on the basis of the contact and the position of contact detected by the touch sensor 131, the time when the contact took place, and the temporal change at the position where the contact took place. The gestures are operations performed on the touch panel 13. The gestures that can be determined by the electronic device 1 include a touch, a release, a tap, a double tap, and the like.

The touch is a gesture of touching the touch panel 13 with a finger. The gesture of touching the touch panel 13 with a finger is determined to be a touch by the electronic device 1.

The release is a gesture of releasing a finger from the touch panel 13. The gesture of releasing a finger from the touch panel 13 is determined to be a release by the electronic device 1.

The tap is a gesture of releasing a finger subsequent to the touch. The gesture of releasing a finger subsequent to the touch is determined to be a tap by the electronic device 1.

The double tap is a gesture of continuously performing the gesture of releasing a finger subsequent to the touch, twice in succession. The gesture of continuously performing the gesture of releasing a finger subsequent to the touch, twice in succession is determined to be a double tap by the electronic device 1.

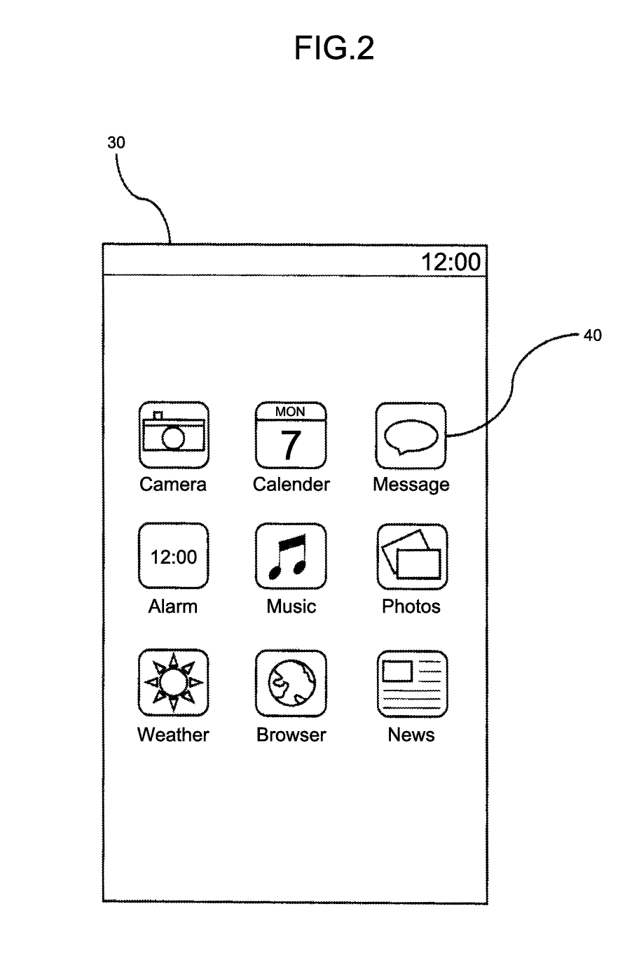

An example of a screen to be displayed on the display 132 of the electronic device 1 will now be described with reference to FIG. 2. FIG. 2 is an example of a home screen. A home screen 30 is displayed on the display 132. The home screen 30 is a screen by which a user can select which application to execute, among a plurality of pieces of application software (hereinafter, simply referred to as applications) that are installed in the electronic device 1. The electronic device 1 executes the application selected through the home screen 30 in the foreground. The screen of the application executed in the foreground is displayed on the display 132.

Icons can be arranged on the home screen 30 of the electronic device 1. A plurality of icons 40 are arranged on the home screen 30 illustrated in FIG. 2. Each of the icons 40 is associated with an application installed in the electronic device 1 in advance. When a gesture on the icon 40 is detected, the electronic device 1 executes the application associated with the icon 40. For example, when a tap on the icon 40 associated with a telephone application (hereinafter, simply referred to as a telephone app) is detected, the electronic device 1 executes the telephone app. The icon 40 includes an image and a character string. The icon 40 may also include a symbol or a figure, instead of the image. The icon 40 does not need to include either the image or the character string. The icons 40 are arranged according to a predetermined rule.

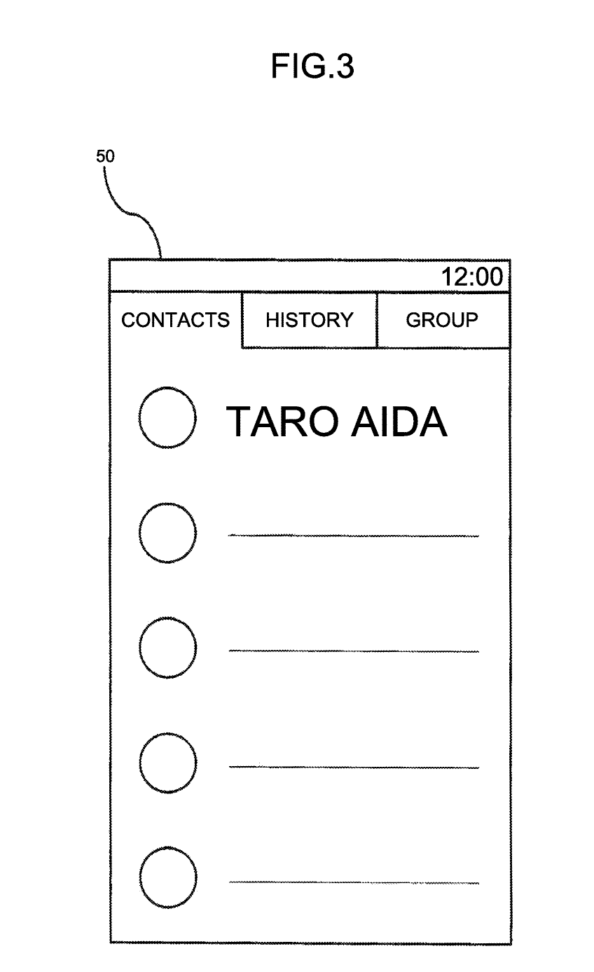

A second example of the screen to be displayed on the display 132 will be described with reference to FIG. 3. FIG. 3 is an example of a screen of an application (may also be referred to as an application screen) to be executed in the electronic device 1. FIG. 3 is an application screen 50 to be displayed in the telephone app. A list of contacts is displayed on the application screen 50. The application screen 50 is not limited to the screen to be displayed when the application is running, but may be various screens to be displayed on the application by a user operation.

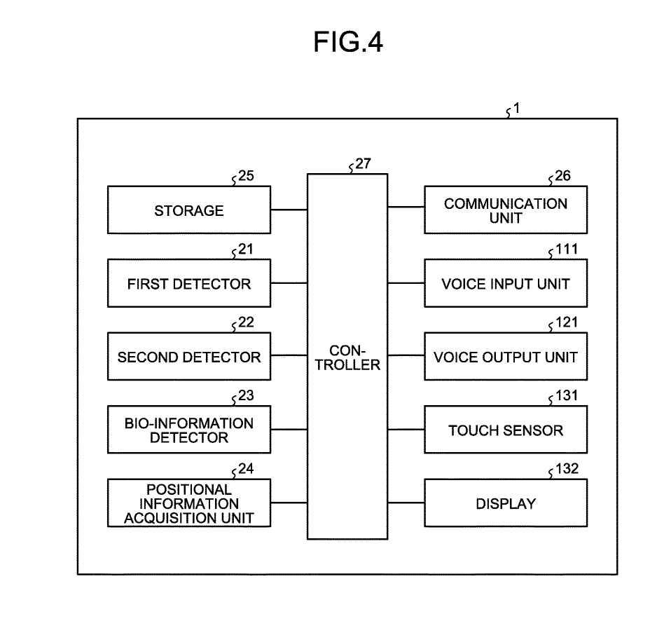

A functional explanation of the electronic device 1 will be described with reference to FIG. 4. FIG. 4 is a block diagram illustrating a functional configuration of the electronic device 1. As illustrated in FIG. 4, the electronic device 1 includes a voice input unit 111, a voice output unit 121, a touch sensor 131, a display 132, a first detector 21, a second detector 22, a bio-information detector 23, a positional information acquisition unit 24, a storage 25, a communication unit 26, and a controller 27.

The voice input unit 111 supplies a signal corresponding to voice the input of which is accepted, to the controller 27. The voice input unit 111 includes the microphone 11 described above. The voice input unit 111 may also be an input interface that can be connected to an external microphone. The external microphone is wirelessly connected or wired to the voice input unit 111. For example, the microphone to be connected to the input interface is a microphone provided on an earphone or the like that can be connected to the electronic device.

The voice output unit 121 outputs voice on the basis of a signal input from the controller 27. The voice output unit 121 includes the speaker 12 described above. The voice output unit 121 may also be an output interface that can be connected to an external speaker. The external speaker is wirelessly connected or wired to the voice output unit 121. For example, the speaker to be connected to the output interface is a speaker provided on the earphone or the like that can be connected to the electronic device.

The touch sensor 131 detects a contact operation by a finger and the like, and supplies a signal corresponding to the detected contact operation to the controller 27.

The display 132 displays objects such as a character, an image, a symbol, and a diagram on a screen, on the basis of a signal input from the controller 27. The objects include, for example, the home screen and the screens of the applications described above.

The first detector 21 detects the state of the electronic device 1, and supplies the detection result to the controller 27. The first detector 21 at least includes an acceleration sensor. The first detector 21 may also include a gyro sensor, a direction sensor, and the like. The acceleration sensor detects the direction and size of acceleration applied to the electronic device 1. The gyro sensor detects the angle and angle speed of the electronic device 1. The direction sensor detects the orientation of the terrestrial magnetism.

The second detector 22 detects the vicinity state of the electronic device 1, and supplies the detection result to the controller 27. For example, the second detector 22 is a proximity sensor, a distance sensor, and the like. The proximity sensor detects the presence of an object in the vicinity in a contactless manner, on the basis of a change in returning time of reflected waves of a light source and the like. The distance sensor detects the distance to an object present in the vicinity, on the basis of a change in returning time of reflected waves of the light source and the like. The second detector 22 may be a sensor that detects the presence of an object in the vicinity and the distance to an object present in the vicinity, by using at least one of visible light, infrared rays, ultraviolet rays, radio waves, sound waves, magnetism, and electrostatic capacity. The second detector is not limited to the proximity sensor, the distance sensor, and the sensor described above, as long as the second detector is a detector capable of detecting the vicinity state of the electronic device 1. For example, the second detector may also be an illumination sensor that detects an amount of light incident on a light receiving element.

The bio-information detector 23 detects bio-information of a user, and supplies the detection result to the controller 27. For example, the bio-information is a face, an iris, a fingerprint, and a voiceprint. However, the bio-information is not limited thereto. For example, a camera provided in the electronic device 1 is used as the bio-information detector 23, to detect the face feature or an iris pattern of a user. Moreover, an electrostatic capacitive fingerprint sensor provided in the electronic device 1 is used to detect the fingerprint of the user. Furthermore, the voice input unit described above is used to detect the voiceprint of the user.

The positional information acquisition unit 24 acquires positional information indicating the current location of the electronic device 1, and supplies the acquired result to the controller 27. For example, the positional information acquisition unit 24 detects the position of the electronic device 1, on the basis of a base station with which a global positioning system (GPS) receiver and the communication unit 26 establish a wireless network.

The storage 25 stores therein computer programs and data. The storage 25 may also be used as a work area for temporarily storing the processing result of the controller 27. The storage 25 may include a semiconductor storage medium and any non-transitory storage medium such as a magnetic storage medium. The storage 25 may also include a variety of storage mediums. The storage 25 may include a combination of a portable storage medium such as a memory card, an optical disc, or an optical magnetic disc, with a storage medium reading device. The storage 25 may also include a storage device used as a temporary storage area such as a random access memory (RAM). The computer programs to be stored in the storage 25 include an application executed in the foreground or background, as well as a control program that supports the operation of the application.

The storage 25 stores therein voice recognition dictionary data and language instruction processing data. The voice recognition dictionary data is data in which a voice feature pattern (feature amount) and a character string are associated with each other. The language instruction processing data is data in which a predetermined character string and a predetermined process to be executed by the controller 27 are associated with each other.

The communication unit 26 communicates wirelessly. For example, wireless communication standards supported by the communication unit 26 include communication standards for cellular phones such as 2G, 3G, and 4G, communication standards for short-range radio, and the like. For example, the communication standards for cellular phones include long term evolution (LTE), wideband code division multiple access (W-CDMA), worldwide interoperability for microwave access (WiMax), CDMA2000, personal digital cellular (PDC), global system for mobile communications (GSM) (registered trademark), personal handy-phone system (PHS), and the like. The communication standards for short-range radio include, for example, Institute of Electrical and Electronics Engineers (IEEE) 802.11, Bluetooth (registered trademark), Infrared Data Association (IrDA), near field communication (NFC), wireless personal area network (WPAN), and the like. The communication standards for the WPAN include, for example, ZigBee (registered trademark). When wireless communication is performed by the communication unit 26 through the communication standards for cellular phones, telephone communication and information communication are performed with the base station, by establishing a wireless network with the base station via a channel allocated by the base station. Moreover, by connecting to an access point (AP) that complies with Wi-Fi (registered trademark), the communication unit 26 can perform information communication via the AP.

The controller 27 is an operation processor. The operation processor includes, for example, a central processing unit (CPU), a system-on-a-chip (SoC), a micro control unit (MCU), a field-programmable gate array (FPGA), and a coprocessor. However, the operation processor is not limited thereto. The controller 27 integrally controls the operation of the electronic device 1 and implements various functions.

The controller 27 detects a change in the acceleration speed and inclination of the electronic device 1, on the basis of the detection result of the first detector 21. The controller 27 may detect a state that the user is holding the electronic device 1 from a state that the user is not holding the electronic device 1, by detecting a change in the acceleration speed and inclination of the electronic device 1.

The controller 27 determines whether the distance between the user and the electronic device 1 has become smaller than a predetermined distance, on the basis of the detection result of the second detector 22. For example, the predetermined distance is 30 cm, but the embodiments are not limited thereto.

The controller 27 performs user authentication by matching the detection result of the bio-information detector 23 and authentication data recorded in the storage 25.

The controller 27 recognizes a position indicating the current location of the user, on the basis of the acquired result of the positional information acquisition unit 24.

The controller 27 executes various controls on the basis of a signal input according to a contact operation and the like detected by the touch sensor 131. For example, when a predetermined contact operation on the touch sensor 131 is detected while the display 132 is in a hidden-display state, the controller 27 changes the display 132 to a display state. Moreover, the controller 27 executes the functions and changes the settings of the electronic device 1, according to the contact operation on the touch sensor 131.

The controller 27 recognizes the voice of the user (voice recognition), by analyzing the voice input to the voice input unit 111. In the voice recognition, the controller 27 reads out a character string from the voice recognition dictionary data stored in the storage 25, on the basis of the feature pattern of the supplied voice.

The controller 27 detects a predetermined word and a sentence from the character string read out from the voice recognition dictionary data, as a voice command. The controller 27 can detect a predetermined process corresponding to the predetermined word or sentence detected (voice command), and execute the process, by referring to the language instruction processing data.

If a change in the electronic device 1 or in the vicinity of the electronic device 1 is detected while the application screen is not being displayed on the display 132, the controller 27 accepts an input of the first voice for displaying the application screen.

A change in the electronic device 1 or in the vicinity of the electronic device 1 may be at least one or a combination of, for example, the electronic device 1 having been held by the user, a predetermined non-contact gesture having been performed, the distance between the user and the electronic device 1 having become smaller than a predetermined distance, and the display 132 having been changed from a hidden-display state to a display state by a predetermined contact operation on the touch sensor 131. In this example, the predetermined contact operation is the double tap described above, for example. However, the embodiments are not limited thereto.

The state that the application screen is not displayed on the display 132 may be a state that the application screen is not displayed on the display 132 but another screen (such as a home screen) is displayed on the display 132, or a hidden-display state (a state that no screen is displayed). The state that the application screen is not displayed on the display 132 may also be a state that the application is running in the background, but the application screen is not displayed on the display 132.

The controller 27 may accept an input of voice only consisting of a word or a sentence (or a character string) having a limited number of characters, as an input of the first voice for displaying the application screen. In this case, the controller 27 does not accept the voice consisting of a word or a sentence (or a character string) exceeding the limited number of characters, as a voice command. For example, the limited number of characters may be ten characters, but the embodiments are not limited thereto. The number of characters in this example may also be a word or a sentence (or a character string) extracted from voice that is continuously input without a predetermined time interval, for example.

The controller 27 may also accept an input of voice only consisting of a word, as an input of the first voice for displaying the application screen. In this case, the controller 27 does not accept the voice consisting of a sentence, as a voice command.

The controller 27 may also accept an input of voice that does not request an input of a voice trigger, as an input of the first voice for displaying the application screen. In this example, the voice trigger is voice consisting of a predetermined word or sentence (or character string) that triggers to start an input of a voice command. Thus, in the electronic device 1 according to some embodiments, the controller 27 may accept an input of the first voice that does not request a voice trigger, if a change in the electronic device 1 or in the vicinity of the electronic device 1 is detected while the application screen is not being displayed on the display 132.

If an input of the first voice for displaying the application screen is detected while an input of the first voice is being accepted, the controller 27 may detect the input of the first voice as a voice command, and display the application screen as a process corresponding to the voice command. The application screen to be displayed is a screen of an application corresponding to the first voice being input, among a plurality of applications. The controller 27 may be set such that the controller 27 does not accept a voice input for executing a process other than the process of displaying the application screen while an input of the first voice for displaying the application screen is being accepted. When an application is running in the background, the controller 27 may change the application to run in the foreground and displaying the application screen on the display 132, according to the input of the first voice while the input of the first voice for displaying the application screen is being accepted.

The controller 27 may accept an input of the first voice only if the user is authenticated. For example, when the user authentication method is a face authentication or an iris authentication using a camera, the controller 27 may accept an input of the first voice after the user is authenticated. When the authentication method is a voiceprint authentication based on the voice input to the voice input unit, the controller 27 first accepts an input of the first voice, and performs a process corresponding to the voice command, after the user is authenticated on the basis of the input voice.

The controller 27 may accept an input of the first voice only if the electronic device 1 is positioned within a predetermined area from a predetermined location. For example, the predetermined location may be user's home, but the embodiments are not limited thereto.

The controller 27 may accept an input of the first voice only if the electronic device 1 is connected to a predetermined wireless network. For example, the electronic device 1 is connected to a predetermined wireless network, when the electronic device 1 is connected to a wireless network through a wireless router personally owned by the user, as an AP. However, the embodiments are not limited thereto.

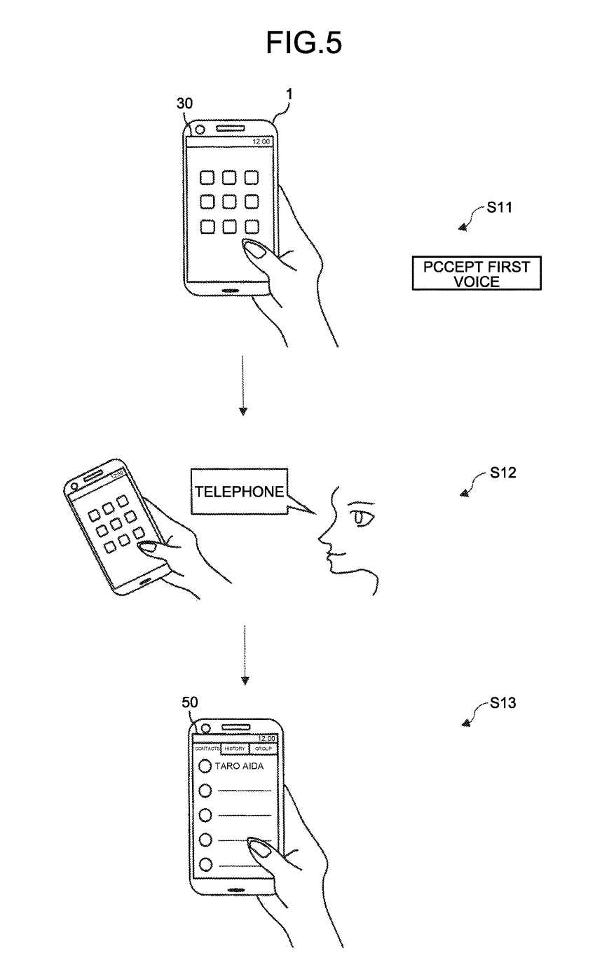

An example of an operation of the electronic device 1 will now be described with reference to FIG. 5. FIG. 5 is an image view illustrating a first example of an operation of the electronic device 1. More specifically, FIG. 5 illustrates a state when a user is operating a telephone app with voice. The controller 27 recognizes the voice of the user input to the voice input unit 111 and performs the process according to the recognized voice.

The user is holding the electronic device 1 on which the home screen 30 is displayed on the display 132 (Step S11). At Step S11, the electronic device 1 starts accepting an input of the first voice, on the basis of the electronic device 1 that is being held by the user (change in the electronic device 1 or in the vicinity of the electronic device 1).

While holding the electronic device 1, the user inputs a voice command of “telephone” (Step S12).

The application screen 50 of the telephone app is displayed on the display 132 (Step S13).

In FIG. 5, the application to be displayed on the display 132 is the telephone app. However, the embodiments are not limited thereto. For example, the application to be displayed on the display 132 corresponding to the first voice may also be a messaging application, a camera application, a map application, and the like.

As described above, the electronic device 1 includes the display 132, the voice input unit 111, detectors (the first detector 21, the second detector 22, and the touch sensor 131) for detecting a change in the electronic device 1 or in the vicinity of the electronic device 1, and the controller 27 for displaying the application screen on the display 132. If a certain change in the electronic device 1 or in the vicinity of the electronic device 1 is detected while the application screen is not being displayed, the controller 27 accepts an input of the first voice for displaying the application screen. Moreover, if a certain change in the electronic device 1 or in the vicinity of the electronic device 1 is detected while the application screen is not being displayed, the controller 27 accepts an input of the first voice that does not request a voice trigger.

In this manner, it is possible to easily display the application screen with voice, if a certain change is made in the electronic device 1 or in the vicinity of the electronic device 1. Consequently, it is possible to improve the operability of the electronic device 1.

The controller 27 may accept an input of the first voice for starting the application and displaying the application screen, if a certain change in the electronic device 1 or in the vicinity of the electronic device 1 is detected while the application is not running in the electronic device 1 according to the embodiments. If an input of the first voice is detected, the controller 27 displays the screen of the application on the display 132 while running the application corresponding to the first voice.

The controller 27 may also accept an input of second voice for executing a process of the application while the application screen is being displayed on the electronic device 1 according to the embodiments. For example, the second voice may be a voice trigger or a voice command subsequent to the input of the voice trigger. The second voice may also be voice consisting of a word or a sentence (or a character string) the number of characters of which is not limited.

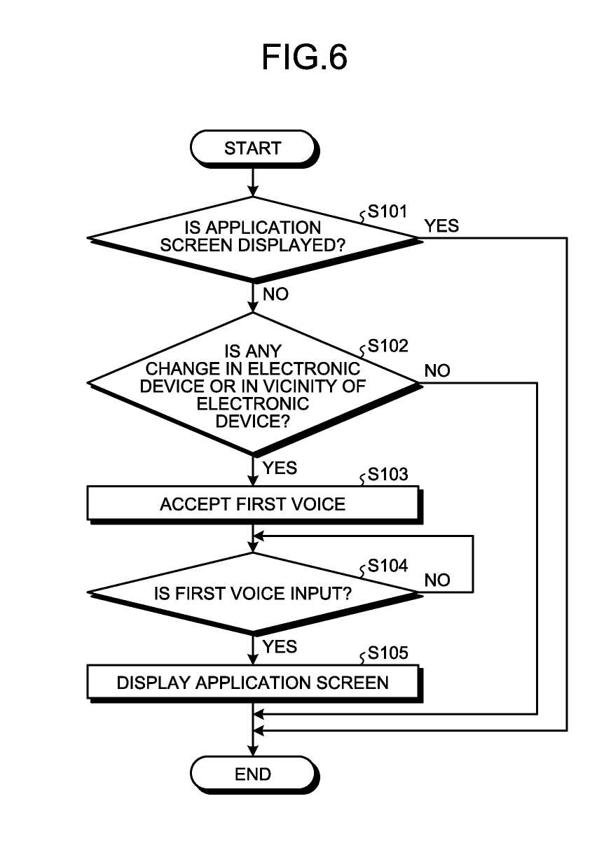

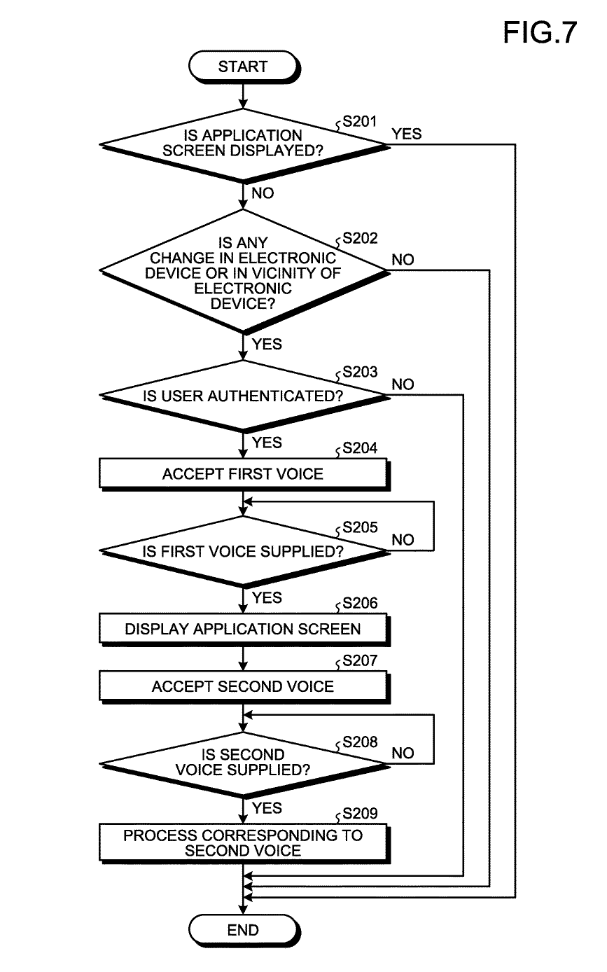

Control executed by the electronic device 1 will be described with reference to FIG. 6 and FIG. 7.

FIG. 6 is a flow chart illustrating a first example of control performed by the electronic device 1. The control performed by the electronic device 1 in FIG. 6 corresponds to the operation of the electronic device 1 in FIG. 5.

The controller 27 determines whether an application screen is displayed on the display 132 (Step S101). If the application screen is displayed on the display 132 (Yes at Step S101), the controller 27 finishes the process. If the application screen is not displayed on the display 132 (No at Step S101), the controller 27 proceeds to Step S102.

The controller 27 determines whether there is any change in the electronic device 1 or in the vicinity of the electronic device 1 (Step S102). If the controller 27 determines that there is no change in the electronic device 1 or in the vicinity of the electronic device 1 (No at Step S102), the controller 27 finishes the process. If the controller 27 that there is a change in the electronic device 1 or in the vicinity of the electronic device 1 (Yes at Step S102), the controller 27 accepts an input of the first voice (Step S103).

The controller 27 then determines whether the user has supplied the first voice (Step S104). If the user has not supplied the first voice (No at Step S104), the controller 27 repeats Step S104. If the user has supplied the first voice (Yes at Step S104), the controller 27 displays a predetermined application screen on the display 132 (Step S105), and finishes the process. The predetermined application screen may be an application corresponding to the first voice among a plurality of applications.

When an application is not running before the first voice is supplied, the process of “displaying the application screen on the display 132” at Step S105 becomes a process of “starting the application and displaying the application screen on the display 132”.

FIG. 7 is a flow chart illustrating a second example of control performed by the electronic device 1.

The controller 27 determines whether the application screen is displayed on the display 132 (Step S201). If the application screen is displayed on the display 132 (Yes at Step S201), the controller 27 finishes the process. If the application screen is not displayed on the display 132 (No at Step S201), the controller 27 proceeds to Step S202.

The controller 27 determines whether there is any change in the electronic device 1 or in the vicinity of the electronic device 1 (Step S202). If the controller 27 determines that there is no change in the electronic device 1 or in the vicinity of the electronic device 1 (No at Step S202), the controller 27 finishes the process. If the controller 27 determines that there is a change in the electronic device 1 or in the vicinity of the electronic device 1 (Yes at Step S202), the controller 27 proceeds to Step S203.

The controller 27 authenticates the user (Step S203). If the user cannot be authenticated (No at Step S203), the controller 27 finishes the process. If the user is authenticated (Yes at Step S203), the controller 27 accepts an input of the first voice (Step S204). The controller 27 then determines whether the user has supplied the first voice (Step S205). If the user has not supplied the first voice (No at Step S205), the controller 27 repeats Step S204. If the user has supplied the first voice (Yes at Step S205), the controller 27 displays the predetermined application screen on the display 132 (Step S206).

When the predetermined application screen is displayed on the display 132, the controller 27 accepts an input of the second voice (Step S207).

The controller 27 then determines whether the user has supplied the second voice (Step S208). If the user has not supplied the second voice (No at Step S208), the controller 27 repeats Step S208. If the user has supplied the second voice (Yes at Step S208), the controller 27 performs a process corresponding to the second voice (Step S209), and finishes the process.

In the control performed in FIG. 7, the controller 27 accepts an input of the first voice if the user is authenticated. Consequently, it is possible to reduce a possibility of the electronic device 1 from being operated by voice of a human being other than the user.

The user authentication at Step S203 may also be the voiceprint authentication on the first voice to be supplied. In this case, the user authentication at Step S203 is performed after Step S205. If the first voice is supplied at Step S205 (Yes at Step S205), the user is authenticated through the voiceprint authentication on the basis of the first voice being supplied. If the user is authenticated, the controller 27 displays the application screen on the display 132.

The process of “user authentication” at Step S203 may also be a process of “determining whether the positional information on the current location of the electronic device 1 is predetermined positional information”. Consequently, it is also possible to reduce a possibility of the electronic device 1 from being operated by voice of a human being other than the user.

The process of “user authentication” at Step S203 may also be a process of “determining whether the electronic device 1 is connected to a predetermined wireless network”. Consequently, it is also possible to reduce a possibility of the electronic device 1 from being operated by voice of a human being other than the user.

When an application is not running before the first voice is supplied, the process of “displaying the application screen on the display 132” at Step S105 becomes a process of “starting the application, and displaying the application screen on the display 132”.

In the control performed at FIG. 7, the input of the second voice command for executing the process of the application is accepted while the application screen is being displayed. Consequently, it is possible to operate the application with voice even after the application screen is displayed, thereby improving the operability of the electronic device 1.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic device, comprising:
a display;
a voice input unit;
a detector configured to detect a certain change in the electronic device or in a vicinity of the electronic device; and
a controller configured to display an application screen on the display, wherein
the controller is configured to accept an input of first voice for displaying the application screen, if the certain change is detected while the application screen is not being displayed.

2. The electronic device according to claim 1, wherein the controller is configured to accept an input of the first voice for starting an application and displaying the application screen, if the certain change is detected while the application is not running.

3. The electronic device according to claim 1, wherein the controller is configured to accept an input of second voice for executing a process of the application while the application screen is being displayed.

4. The electronic device according to claim 1, further comprising:
a first detector configured to detect whether the electronic device is being held, wherein
the certain change includes the electronic device having been held.

5. The electronic device according to claim 1, further comprising:
a second detector configured to detect a non-contact gesture, wherein
the certain change includes a predetermined non-contact gesture having been performed.

6. The electronic device according to claim 1, further comprising:
a second detector configured to detect distance between a user and the electronic device, wherein
the certain change includes the distance between the user and the electronic device having become smaller than a predetermined distance.

7. The electronic device according to claim 1, further comprising:
a third detector configured to detect a contact operation, wherein
the certain change includes the display having been changed from a hidden-display state to a display state by a predetermined contact operation.

8. The electronic device according to claim 4, further comprising:
a bio-information detector configured to detect bio-information of a user and authenticate the user by matching recorded authentication data with the bio-information, wherein
the controller is configured to accept an input of the first voice if the user is authenticated by the bio-information detector.

9. The electronic device according to claim 4, further comprising:
a bio-information detector configured to detect bio-information of a user and authenticate the user by matching recorded authentication data with the bio-information, wherein
the controller is configured to authenticate the user if the first voice is supplied, and perform a process corresponding to the first voice if the user is authenticated.

10. The terminal device according to claim 4, further comprising:
a positional information acquisition unit configured to acquire positional information indicating a current location of the terminal device, wherein
the controller is configured to accept an input of the first voice, if the terminal device is positioned within a predetermined area from a predetermined location.

11. The terminal device according to claim 4, further comprising:
a communication unit configured to communicate wirelessly, wherein
the controller is configured to accept an input of the first voice while the communication unit is connected to a predetermined wireless network.

12. A control method of an electronic device that includes a display, a voice input unit, a detector for detecting a certain change in the electronic device or in a vicinity of the electronic device, and a controller for displaying an application screen on the display, the control method comprising:
detecting the certain change while the application screen is not being displayed; and
accepting an input of first voice for displaying the application screen.

13. A non-transitory storage medium that stores a control program for causing, when executed by an electronic device including a display, a voice input unit, a detector configured to detect a certain change in the electronic device or a vicinity of the electronic device, and a controller configured to display an application screen on the display, the electronic device to execute:
detecting the certain change while the application screen is not being displayed, and
accepting an input of first voice for displaying the application screen.
